(19) United States
(12) Patent Application Publication
(10) Pub. No.: US 2025/0015339 A1
(43) Pub. Date: Jan. 9, 2025

(54) ZINC SECONDARY BATTERY

(71) Applicant: NGK INSULATORS, LTD., Nagoya-shi (JP)

(72) Inventor: Junki MATSUYA, Chita-gun (JP)

(21) Appl. No.: 18/890,945

(22) Filed: Sep. 20, 2024

Related U.S. Application Data
(63) Continuation of application No. PCT/JP2022/039699, filed on Oct. 25, 2022.

(30) Foreign Application Priority Data
Mar. 28, 2022 (JP) 2022-052172

(51) Int. Cl. H01M 10/054; H01M 4/02; H01M 4/131; H01M 4/48; H01M 50/431; H01M 50/491; H01M 50/497; H01M 50/536; H01M 50/54

(52) U.S. Cl. CPC H01M 10/054; H01M 4/131; H01M 4/48; H01M 50/431; H01M 50/491; H01M 50/497; H01M 50/536; H01M 50/54; H01M 2004/028

(57) ABSTRACT

Provided is a zinc secondary battery including a positive electrode plate including a positive electrode active material layer and a positive electrode current collector; a positive electrode tab lead extending from an end of the positive electrode plate; a negative electrode plate including a negative electrode active material layer and a negative electrode current collector; a negative electrode tab lead extending from an end of the negative electrode plate; a hydroxide ion conductive separator; and an electrolytic solution. The electrode plates, the electrode tab leads, and the hydroxide ion conductive separator are vertically arranged respectively. The electrode plate has, along an upper end of the electrode plate, an uncoated region free from the electrode active material layer, and the electrode tab lead is weld-bonded to the current collector in the uncoated region, and an insulating tape is attached to the uncoated region to cover the weld-bonded portion.

### CROSS-REFERENCE TO RELATED APPLICATIONS

This application is a continuation application of PCT/JP2022/039699 filed Oct. 25, 2022, which claims priority to Japanese Patent Application No. 2022-052172 filed Mar. 28, 2022, the entire contents all of which are incorporated herein by reference.

### BACKGROUND OF THE INVENTION

### 1. Field of the Invention

The present disclosure relates to a zinc secondary battery.

### 2. Description of the Related Art

It is known that in zinc secondary batteries such as a nickel-zinc secondary battery and an air-zinc secondary battery, metallic zinc in a dendrite form precipitates from a negative electrode upon charge, penetrates voids of a separator such as a nonwoven fabric, and reaches a positive electrode, resulting in occurrence of a short circuit. This short circuit due to such zinc dendrites leads to shorten repeated charge/discharge life.

In order to deal with the problems described above, a battery comprising a layered double hydroxide (LDH) separator that blocks the penetration of zinc dendrite while selectively permeating hydroxide ions has been proposed. For example, Patent Literature 1 (WO2013/118561) discloses a nickel-zinc secondary battery including a LDH separator provided between a positive electrode and a negative electrode. Patent Literature 2 (WO2016/076047) discloses a separator structure comprising an LDH separator fitted or joined to a resin outer frame, wherein the LDH separator has a high denseness such that it has a gas impermeability and/or water impermeability. Moreover, the literature also discloses that the LDH separator can be composited with a porous substrate. Further, Patent Literature 3 (WO2016/067884) discloses various methods for forming an LDH dense membrane on a surface of a porous substrate to obtain a composite material. This method comprises steps of uniformly adhering a starting material that can impart a starting point for LDH crystal growth to the porous substrate, treating hydrothermally the porous substrate in a raw material aqueous solution to form an LDH dense membrane on a surface of the porous substrate. An LDH separator further densified by roll pressing of a composite material of an LDH/porous substrate produced by hydrothermal treatment has been also proposed. For example, Patent Literature 4 (WO2019/124270) discloses an LDH separator comprising a polymer porous substrate, and an LDH filled in the porous substrate, and having a linear transmittance at a wavelength of 1000 nm of 1% or more.

Moreover, LDH-like compounds have being known as hydroxides and/or oxides with a layered crystal structure that cannot be called LDH but are analogous thereto, which exhibit hydroxide ion conductive properties similar to those of a compound to an extent that it can be collectively referred to as hydroxide ion conductive layered compounds together with LDH. For example, Patent Literature 5 (WO2020/255856) discloses a hydroxide ion conductive separator comprising a porous substrate and a layered double hydroxide (LDH)-like compound that clogs up pores in the porous substrate, in which the LDH-like compound is a hydroxide and/or an oxide with a layered crystal structure containing Mg, and one or more elements including at least Ti and selected from the group consisting of Ti, Y and Al. It is described that this hydroxide ion conductive separator is excellent in alkali resistance as compared with a conventional LDH separator, and can further effectively inhibit a short circuit due to zinc dendrite.

By the way, Patent Literature 6 (WO2019/069760) and Patent Literature 7 (WO2019/077953) have proposed a zinc secondary battery having a configuration in which the whole of a negative electrode active material layer is covered or wrapped up with a liquid holding member and an LDH separator, and a positive electrode active material layer is covered or wrapped up with a liquid holding member. As the liquid holding member, a nonwoven fabric is used. It is described that according to such a configuration, complicated sealing and bonding between the LDH separator and a battery container is unnecessary, and hence a zinc secondary battery (especially a stacked-cell battery thereof) capable of preventing zinc dendrite propagation can be produced extremely easily and with high productivity. Patent Literature 8 (WO2021/193436) has disclosed a zinc secondary battery in which a laminate alternately including a positive electrode plate and a negative electrode plate, a positive electrode current collector tab connected to a positive electrode current collector in the positive electrode plate, and a negative electrode current collector tab connected to a negative electrode current collector in the negative electrode plate are vertically arranged, and the positive electrode current collector tab and the negative electrode current collector tab are projecting upward from the laminate.

### CITATION LIST

### Patent Literature

Patent Literature 1: WO2013/118561
Patent Literature 2: WO2016/076047
Patent Literature 3: WO2016/067884
Patent Literature 4: WO2019/124270
Patent Literature 5: WO2020/255856
Patent Literature 6: WO2019/069760
Patent Literature 7: WO2019/077953
Patent Literature 8: WO2021/193436

### SUMMARY OF THE INVENTION

In producing a zinc secondary battery of a type in which a current collector tab extends upward from an electrode laminate (hereinafter referred to as the upward tab type) as disclosed in Patent Literature 8, a tab lead (current collector tab) is connected to an electrode current collector by welding, and the tab lead is connected to an electrode terminal. FIGS. 9A and 9B illustrate an example of a zinc secondary battery 110 of such an upward tab type. The zinc secondary battery 110 includes an electrode laminate 111 that includes a positive electrode plate 112 including a positive electrode active material layer 112a and a positive electrode current collector 112b, and a negative electrode plate 114 including a negative electrode active material layer 114a and a negative electrode current collector 114b. Above the positive electrode plate 112 (or the negative electrode plate 114), an uncoated region U in which the positive electrode current collector 112b (or the negative electrode current collector 114b) is exposed without being covered with the positive electrode active material layer 112a (or the negative electrode active material layer 114a) is present as illustrated in FIG. 10, and a positive electrode tab lead 113 (or a negative electrode tab lead 115) is bonded by welding to this uncoated region U. The positive electrode plate 112 (or the negative electrode plate 114) is covered or wrapped up with a hydroxide ion conductive separator 116 and/or a liquid holding member 117 as illustrated in FIG. 11. Then, as illustrated in FIGS. 9A and 9B, the positive electrode tab leads 113 extending from a plurality of positive electrode plates 112 are together bonded to a positive electrode terminal 126 in a positive electrode tab bonding portion 130, and the negative electrode tab leads 115 extending from a plurality of negative electrode plates 114 are together bonded to a negative electrode terminal 128 in a negative electrode tab bonding portion 132.

If, however, the tab leads 113 or 115 and the current collectors 112b or 114b are insufficiently welded, the tab leads 113 or 115 may be peeled off (or partially come off) from the current collector 112b or 114b due to a load caused in collecting the plurality of tab leads 113 or 115. For example, such peeling may be caused by a load due to expansion/shrinkage of the positive electrode plate 112 and/or the negative electrode plate 114 at the time of charge/discharge. In such a case, a sharp end of the tab lead 113 or 115 may break through the hydroxide ion conductive separator 116 and/or the liquid holding member 117 present in the vicinity, which may cause a short circuit S.

The inventors have now found that, in a zinc secondary battery of the upward tab type, a short circuit becomes less likely to occur by attaching an insulating tape to an uncoated region of an electrode plate in such a manner as to cover a portion where a tab lead is weld-bonded.

Accordingly, an object of the present invention is to provide a zinc secondary battery of an upward tab type in which a short circuit is less likely to occur.

The present invention provides the following aspects:

### [Aspect 1]

A zinc secondary battery, comprising:
a positive electrode plate including a positive electrode active material layer and a positive electrode current collector;
a positive electrode tab lead extending from an end of the positive electrode plate;
a negative electrode plate including a negative electrode active material layer containing at least one selected from the group consisting of zinc, zinc oxide, a zinc alloy, and a zinc compound, and a negative electrode current collector;
a negative electrode tab lead extending from an end of the negative electrode plate at a position not overlapping with the positive electrode tab lead;
a hydroxide ion conductive separator separating the positive electrode plate and the negative electrode plate so as to make hydroxide ions conductible; and
an electrolytic solution,
wherein each of the positive electrode plate, the positive electrode tab lead, the negative electrode plate, the negative electrode tab lead, and the hydroxide ion conductive separator is vertically arranged, and the positive electrode tab lead and the negative electrode tab lead extend upward,
wherein the positive electrode plate has, along an upper end of the positive electrode plate, an uncoated region free from the positive electrode active material layer, and the positive electrode tab lead is weld-bonded to the positive electrode current collector in the uncoated region, and an insulating tape is attached to the uncoated region in such a manner as to cover the weld-bonded portion with the insulating tape, and/or
wherein the negative electrode plate has, along an upper end of the negative electrode plate, an uncoated region free from the negative electrode active material layer, and the negative electrode tab lead is weld-bonded to the negative electrode current collector in the uncoated region, and an insulating tape is attached to the uncoated region in such a manner as to cover the weld-bonded portion with the insulating tape.

### [Aspect 2]

The zinc secondary battery according to aspect 1, wherein 60% or more of an area of the uncoated region on both surfaces of the positive electrode plate is covered with the insulating tape, and/or 60% or more of an area of the uncoated region on both surfaces of the negative electrode plate is covered with the insulating tape.

### [Aspect 3]

The zinc secondary battery according to aspect 1 or 2,
wherein a lower end of the insulating tape on the positive electrode plate is positioned between an upper end of the positive electrode active material layer and a lower end of the positive electrode tab lead, and/or
wherein a lower end of the insulating tape on the negative electrode plate is positioned between an upper end of the negative electrode active material layer and a lower end of the negative electrode tab lead.

### [Aspect 4]

The zinc secondary battery according to any one of aspects 1 to 3,
wherein the insulating tape is attached to both surfaces of the uncoated region of the positive electrode plate in such a manner as to have an upper end of the insulating tape positioned above an upper end of the positive electrode current collector, whereby upper end portions of the insulating tape protruding beyond the upper end of the positive electrode current collector are attached to each other, and/or
wherein the insulating tape is attached to both surfaces of the uncoated region of the negative electrode plate in such a manner as to have an upper end of the insulating tape positioned above an upper end of the negative electrode current collector, whereby upper end portions of the insulating tape protruding beyond the upper end of the negative electrode current collector are attached to each other.

### [Aspect 5]

The zinc secondary battery according to aspect 4,
wherein the insulating tape is attached to both surfaces of the uncoated region of the positive electrode plate in such a manner as to have left and right ends of the insulating tape positioned outside left and right ends of the positive electrode current collector, and left and right end portions of the insulating tape protruding beyond the left and right end of the positive electrode current collector are attached to each other, and/or
wherein the insulating tape is attached to both surfaces of the uncoated region of the negative electrode plate in such a manner as to have left and right ends of the insulating tape positioned outside left and right ends of the negative electrode current collector, and left and right end portions of the insulating tape protruding beyond the left and right end of the negative electrode current collector are attached to each other.

### [Aspect 6]

The zinc secondary battery according to any one of aspects 1 to 5, wherein the positive electrode plate and/or the negative electrode plate is covered or wrapped up with the hydroxide ion conductive separator.

### [Aspect 7]

The zinc secondary battery according to any one of aspects 1 to 6, wherein not only the hydroxide ion conductive separator but also a liquid holding member is interposed between the positive electrode plate and the negative electrode plate.

### [Aspect 8]

The zinc secondary battery according to aspect 7, wherein the positive electrode plate and/or the negative electrode plate is covered or wrapped up with the liquid holding member.

### [Aspect 9]

The zinc secondary battery according to any one of aspects 1 to 8, wherein the hydroxide ion conductive separator is an LDH separator containing a layered double hydroxide (LDH) and/or an LDH-like compound.

### [Aspect 10]

The zinc secondary battery according to aspect 9, wherein the LDH separator further includes a porous substrate, and is composited with the porous substrate with the LDH and/or the LDH-like compound filled in pores in the porous substrate.

### [Aspect 11]

The zinc secondary battery according to any one of aspects 1 to 10, wherein the positive electrode active material layer contains nickel hydroxide and/or nickel oxyhydroxide, whereby the zinc secondary battery is configured as a nickel zinc secondary battery.

### [Aspect 12]

The zinc secondary battery according to any one of aspects 1 to 10, wherein the positive electrode active material layer is an air electrode layer, whereby the zinc secondary battery is configured as an air-zinc secondary battery.

### [Aspect 13]

The zinc secondary battery according to any one of aspects 1 to 12, comprising a plurality of unit cells each including a pair of the positive electrode plate and the negative electrode plate together with the hydroxide ion conductive separator, whereby the plurality of the unit cells form a multilayer cell as a whole.

### BRIEF DESCRIPTION OF THE DRAWINGS

FIG. 1 is a schematic cross-sectional view illustrating an example of a zinc secondary battery of the present invention.

FIG. 2 is a view schematically illustrating A-A′ cross section of the zinc secondary battery shown in FIG. 1.

FIG. 3 is a perspective view schematically illustrating an electrode laminate of the zinc secondary battery shown in FIG. 1.

FIG. 4A is a cross-sectional view schematically illustrating the electrode laminate of the zinc secondary battery shown in FIG. 1.

FIG. 4B is a cross-sectional view schematically illustrating a state, in the electrode laminate shown in FIG. 4A, in which a tab lead is peeled off.

FIG. 5 is a perspective view illustrating an example of a positive electrode plate or a negative electrode plate to which an insulating tape is attached in the zinc secondary battery shown in FIG. 1.

FIG. 6 is a perspective view illustrating an aspect of the positive electrode plate or the negative electrode plate shown in FIG. 5 covered with a hydroxide ion conductive separator or a liquid holding member.

FIG. 7 is a diagram illustrating an example of an attaching position of the insulating tape in the zinc secondary battery shown in FIG. 1.

FIG. 8 is a diagram illustrating another example of the attaching position of the insulating tape in the zinc secondary battery shown in FIG. 1.

FIG. 9A is a cross-sectional view schematically illustrating an electrode laminate of a conventional zinc secondary battery.

FIG. 9B is a cross-sectional view schematically illustrating a state, in the electrode laminate shown in FIG. 9A, in which a tab lead is peeled off.

FIG. 10 is a perspective view illustrating a positive electrode plate or a negative electrode plate in the conventional zinc secondary battery shown in FIGS. 9A and 9B.

FIG. 11 is a perspective view illustrating an aspect of the positive electrode plate or the negative electrode plate shown in FIG. 10 covered with a hydroxide ion conductive separator or a liquid holding member.

### DETAILED DESCRIPTION OF THE INVENTION

### Zinc Secondary Battery

A zinc secondary battery of the present invention is not especially limited as long as it is a secondary battery using zinc as a negative electrode and using an alkaline electrolytic solution (representatively, an alkali metal hydroxide aqueous solution). Accordingly, it can be a nickel-zinc secondary battery, a silver oxide-zinc secondary battery, a manganese oxide-zinc secondary battery, an air-zinc secondary battery, or any of other various alkaline zinc secondary batteries. For example, it is preferred that a positive electrode active material layer contains nickel hydroxide and/or nickel oxyhydroxide, whereby the zinc secondary battery is configured as a nickel-zinc secondary battery. Alternatively, a positive electrode active material layer may be an air electrode layer, whereby the zinc secondary battery is configured as an air-zinc secondary battery.

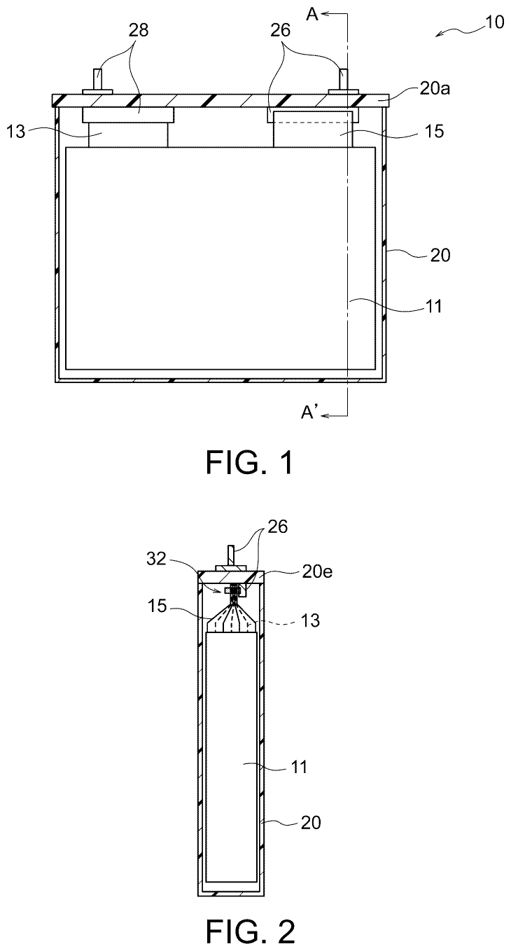

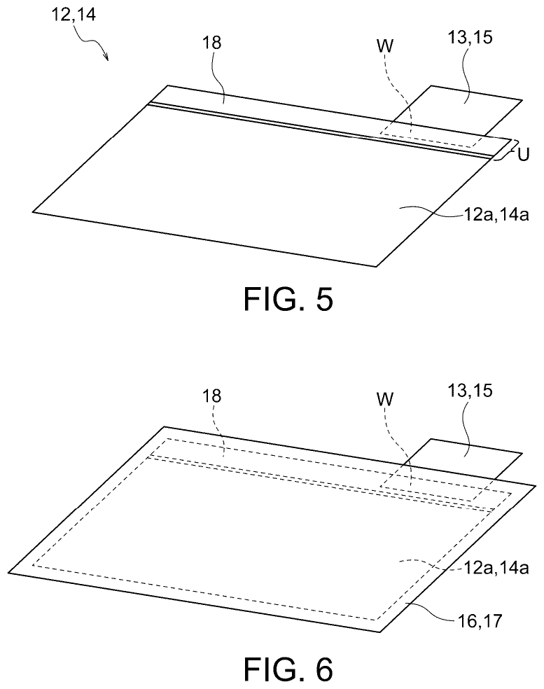

FIGS. 1 to 6 illustrate a zinc secondary battery 10 according to one aspect of the present invention, and components thereof. The zinc secondary battery 10 includes an electrode laminate 11 and an electrolytic solution (not shown) housed in a battery case 20, and the electrode laminate 11 includes a positive electrode plate 12, a positive electrode tab lead 13, a negative electrode plate 14, a negative electrode tab lead 15, and a hydroxide ion conductive separator 16. The positive electrode plate 12 includes a positive electrode active material layer 12a and a positive electrode current collector 12b, and the positive electrode tab lead 13 extends from an end of the positive electrode plate 12. The negative electrode plate 14 includes a negative electrode active material layer 14a and a negative electrode current collector 14b, and the negative electrode tab lead 15 extends from an end of the negative electrode plate 14 at a position not overlapping with the positive electrode tab lead 13. The negative electrode active material layer 14a contains at least one selected from the group consisting of zinc, zinc oxide, a zinc alloy, and a zinc compound. The hydroxide ion conductive separator 16 separates the positive electrode plate 12 and the negative electrode plate 14 such that hydroxide ions can be conducted. Each of the positive electrode plate 12, the positive electrode tab lead 13, the negative electrode plate 14, the negative electrode tab lead 15, and the hydroxide ion conductive separator 16 is vertically arranged, and the positive electrode tab lead 13 and the negative electrode tab lead 15 extend upward. The positive electrode plate 12 has, along an upper end of the positive electrode plate 12, an uncoated region U free from the positive electrode active material layer 12a, and in this uncoated region U, the positive electrode tab lead 13 is weld-bonded to the positive electrode current collector 12b, and an insulating tape 18 is attached to the uncoated region U in such a manner as to cover a weld-bonded portion W with the insulating tape 18. Additionally/alternatively, the negative electrode plate 14 has, along an upper end of the negative electrode plate 14, an uncoated region U free from the negative electrode active material layer 14a, and in this uncoated region U, the negative electrode tab lead 15 is weld-bonded to the negative electrode current collector 14b, and the insulating tape 18 is attached to the uncoated region U in such a manner as to cover a weld-bonded portion W with the insulating tape 18. In this manner, in the zinc secondary battery 10 of the upward tab type, the insulating tape 18 is attached to the uncoated region U of the electrode plate 12 or 14 so as to cover the portion in which the tab lead 13 or 15 is weld-bonded, and thus, a short circuit is less likely to occur.

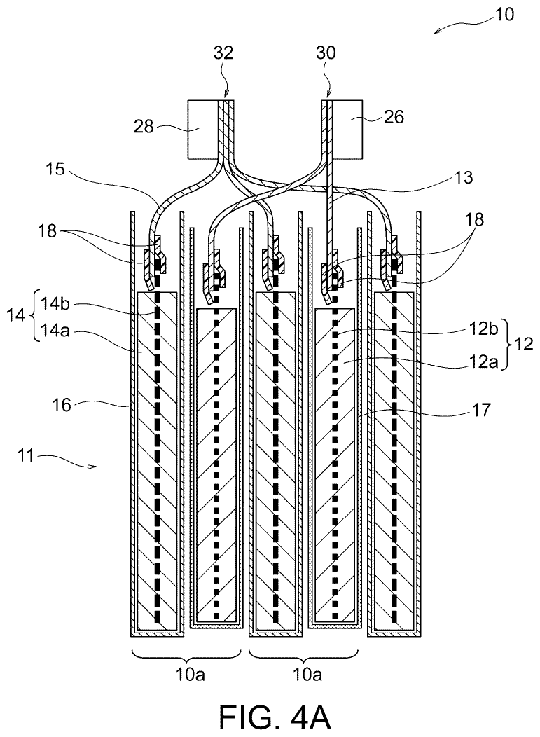

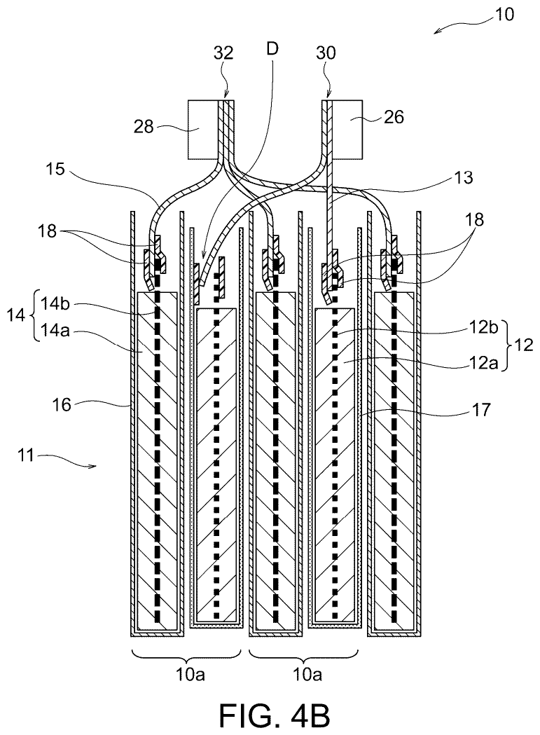

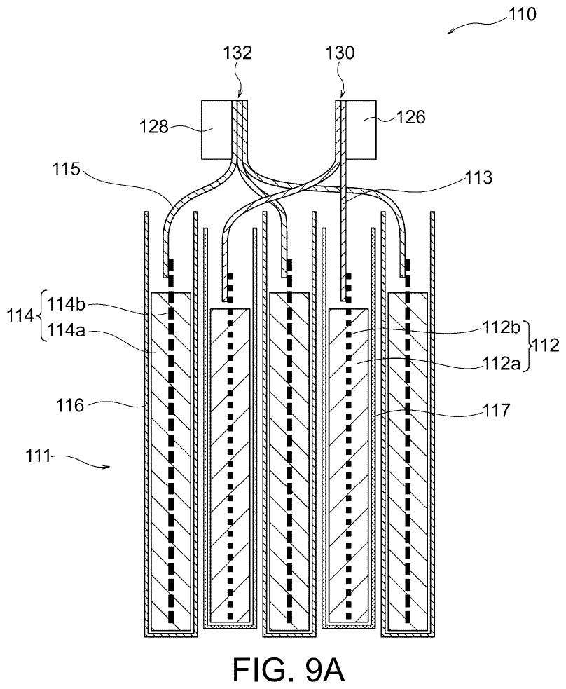

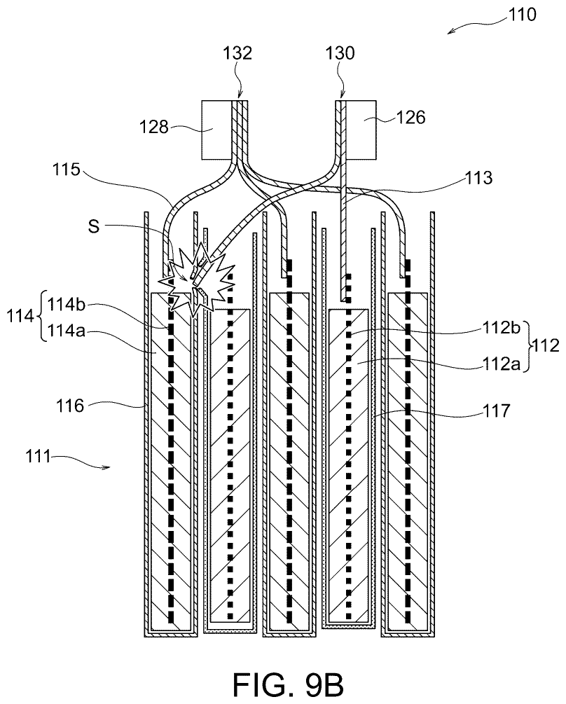

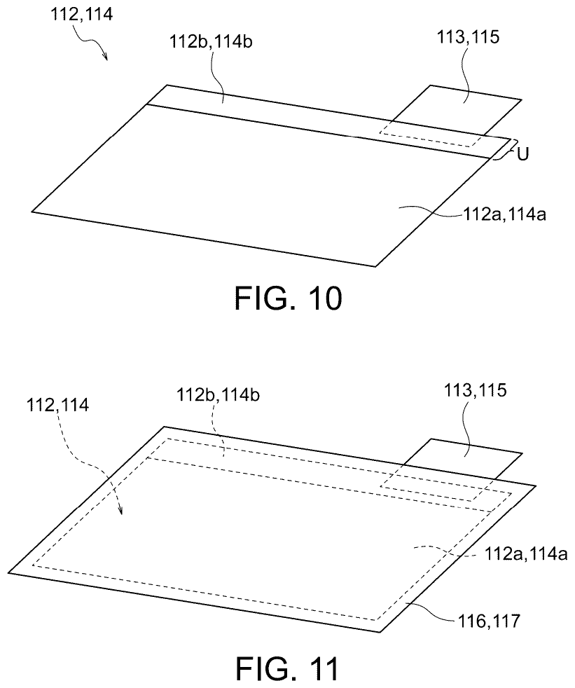

Specifically, as described above referring to FIGS. 9A to 11, in a conventional zinc secondary battery 110 of the upward tab type, a tab lead 113 or 115 is connected by welding to a current collector 112b or 114b, and this tab lead 113 or 115 is connected to an electrode terminal 126 or 128. If, however, the tab lead 113 or 115 and the current collector 112b or 114b are insufficiently welded, the tab lead 113 or 115 may be peeled off (or partially come off) from the current collector 112b or 114b due to a load caused in collecting a plurality of tab leads 113 or 115. For example, such peeling may occur by a load caused due to expansion/shrinkage of the positive electrode plate 112 and/or the negative electrode plate 114 at the time of charge/discharge. In such a case, a sharp end of the tab lead 113 or 115 may break through a hydroxide ion conductive separator 116 and/or a liquid holding member 117 present in the vicinity, which may cause a short circuit S. On the contrary, in the zinc secondary battery 10 of the present invention, the insulating tape 18 is attached to the uncoated region U of the electrode plate 12 or 14 so as to cover the portion in which the tab lead 13 or 15 is weld-bonded, and therefore, a short circuit is less likely to occur. This is because, owing to the insulating tape 18 covering the welded portion of the tab lead 13 or 15, i) the welded portion W of the tab lead 13 or 15 is less likely to peel off, and ii) even if the tab lead 13 or 15 peels off in the welded portion W and contacts, at the tip thereof, another component, the tab lead 13 or 15 contacts another component (such as the hydroxide ion conductive separator 16 or the liquid holding member 17) with its tip protected by the insulating tape 18 as illustrated as a peeling D in FIG. 4B. Specifically, the tip of the tab lead 13 or 15 is less likely to penetrate the hydroxide ion conductive separator 16 or the liquid holding member 17, and in addition, if the tip penetrates these to contact the electrode plate 12 or 14, the insulating tape 18 functions as an insulating material, and hence a short circuit is less likely to occur.

The insulating tape 18 is preferably applied to both the positive electrode plate 12 and the negative electrode plate 14 as in the illustrated example, but may be applied to only one of the positive electrode plate 12 and the negative electrode plate 14. Also in this case, a short circuit caused due to peeling of one of the positive electrode tab lead 13 and the negative electrode tab lead 15 is less likely to occur. The insulating tape 18 is not especially limited, and a commercially available insulating tape may be used. The insulating tape 18 typically includes a substrate composed of an insulating resin, and an adhesive layer or a pressure-sensitive adhesive layer provided on the substrate. An example of the insulating resin includes polypropylene. The thickness of the insulating tape 18 is preferably 30 to 70 μm, and more preferably 40 to 60 μm. When the insulating tape has such a thickness, a level difference between the positive electrode active material layer 12a and the positive electrode current collector 12b, or a level difference between the negative electrode active material layer 14a and the negative electrode current collector 14b can be favorably filled, and thus, the upper end of the positive electrode active material layer 12a or the negative electrode active material layer 14a is less likely to be damaged. Accordingly, it is preferred to use an insulating tape 18 having a thickness not larger than the level difference between the positive electrode active material layer 12a and the positive electrode current collector 12b, or the level difference between the negative electrode active material layer 14a and the negative electrode current collector 14b.

The positive electrode plate 12 includes the positive electrode active material layer 12a. A positive electrode active material contained in the positive electrode active material layer 12a is not especially limited, and may be appropriately selected from known positive electrode materials in accordance with the type of zinc secondary battery. For example, in a nickel-zinc secondary battery, a positive electrode containing nickel hydroxide and/or nickel oxyhydroxide may be used. In this case, the positive electrode active material layer 12a may contain an additive that is at least one selected from the group consisting of a silver compound, a manganese compound, and a titanium compound, and thus, a positive electrode reaction for absorbing hydrogen gas generated through a self-discharge reaction can be accelerated. Besides, the positive electrode active material layer 12a may further contain cobalt. Cobalt is contained in the positive electrode plate 12 preferably in the form of cobalt oxyhydroxide. In the positive electrode active material layer 12a, cobalt functions as a conductive auxiliary agent to contribute to improvement of charge/discharge capacity. Alternatively, in an air-zinc secondary battery, an air electrode may be used as the positive electrode.

The positive electrode plate 12 further includes the positive electrode current collector 12b. A preferred example of the positive electrode current collector 12b includes a nickel porous substrate such as a foam nickel plate. In this case, for example, when a paste containing an electrode active material such as nickel hydroxide is uniformly applied on a nickel porous substrate, and the resultant is dried, a positive electrode plate including a positive electrode/positive electrode current collector can be favorably produced. At this point, it is also preferred that the dried positive electrode plate (namely, the positive electrode/positive electrode current collector) is subjected to pressing to prevent the electrode active material from coming off and to improve electrode density. When the positive electrode current collector 12b is a nickel porous substrate such as a foam nickel plate, the uncoated region of the positive electrode current collector 12b may be processed into a tab by pressing.

The positive electrode tab lead 13 is provided to extend from the end of the positive electrode plate 12. The positive electrode tab lead 13 is not especially limited, and a commercially available sheet metal piece may be used. It is preferred that a plurality of positive electrode tab leads 13 are bonded to one positive electrode terminal 26 or a member electrically connected thereto to constitute a positive electrode tab bonding portion 30. In this manner, current collection can be conducted with a simple configuration and with high space efficiency, and connection to the positive electrode terminal 26 can be eased. The bonding between the positive electrode tab lead 13 and the positive electrode current collector 12b, and a member such as the positive electrode terminal 26 may be conducted by any of known bonding methods such as ultrasonic welding (ultrasonic bonding), laser welding, TIG welding, and resistance welding.

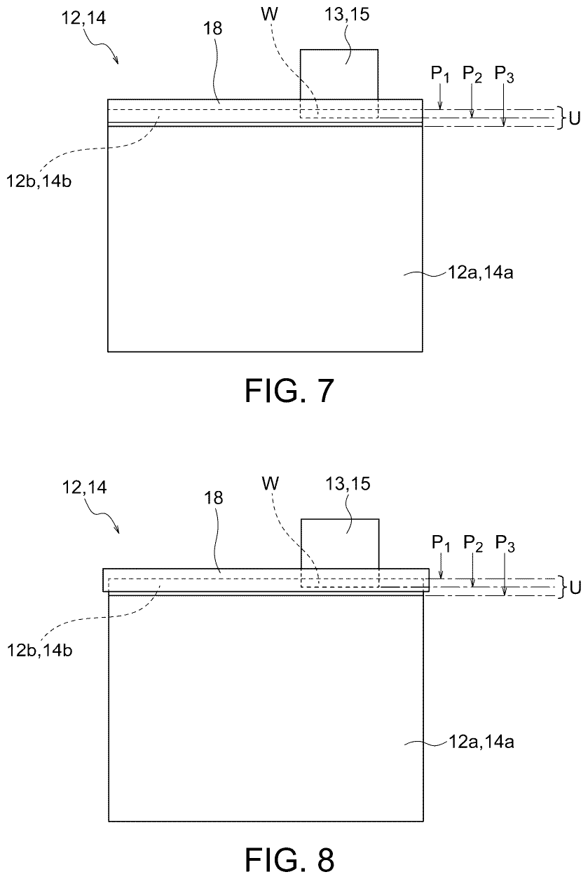

As illustrated in FIG. 7, the positive electrode plate 12 has, along the upper end of the positive electrode plate 12, the uncoated region U free from the positive electrode active material layer 12a, and in the uncoated region U, the positive electrode tab lead 13 is weld-bonded to the positive electrode current collector 12b. The insulating tape 18 is attached to the uncoated region U in such a manner as to cover the weld-bonded portion W with the insulating tape 18. Owing to this configuration, a short circuit due to peeling of the positive electrode tab lead 13 is less likely to occur as described above. The insulating tape 18 is attached preferably to both surfaces of the positive electrode plate 12. In this case, separate insulating tapes 18 may be attached respectively to one surface and the other surface of the positive electrode plate 12, or one insulating tape 18 may be turned around to be attached to both surfaces of the positive electrode plate 12. In the latter case, one insulating tape 18 may be wound around both surfaces of the positive electrode plate 12 at least once, and in this case, the insulating tape 18 and the positive electrode tab lead 13 are even less likely to peel off. It is preferred that 60% or more, more preferably 70% or more, further preferably 80% or more, and ideally 100% of the area (including the area of a pore if the pore is present) of the uncoated region U on both surfaces of the positive electrode plate 12 is covered with the insulating tape. In this manner, a bonding area between the positive electrode current collector 12b and the insulating tape 18 is increased, and hence the insulating tape 18 is less likely to peel.

The lower end of the insulating tape 18 on the positive electrode plate 12 is preferably positioned between an upper end P₃ of the positive electrode active material layer and a lower end P₂ of the positive electrode tab lead 13. In this case, the lower end of the insulating tape 18 is positioned lower than the lower end P₂ of the positive electrode tab lead 13, and therefore, the tip of the positive electrode tab lead 13 is protected by the insulating tape 18, and thus, the positive electrode tab lead 13 is even less likely to peel, and even if the positive electrode tab lead 13 peels, a short circuit is less likely to occur. Besides, the lower end of the insulating tape 18 is positioned above the upper end P₃ of the positive electrode active material layer 12a, and therefore, a capacity loss can be prevented. Specifically, when the positive electrode active material layer 12a is covered with the insulating tape 18, a region not contributing to a reaction is unavoidably formed, which reduces the battery capacity, but when the above-described configuration is employed, the positive electrode active material layer 12a is not covered with the insulating tape 18, and hence, this problem can be avoided.

It is preferred that the insulating tape 18 is attached onto both surfaces of the uncoated region U of the positive electrode plate 12 in such a manner as to have the upper end of the insulating tape 18 positioned above an upper end P₁ of the positive electrode current collector 12b, and thus, upper end portions of the insulating tape 18 protruding beyond the upper end P₁ of the positive electrode current collector 12b are attached to each other. In this manner, the end of the positive electrode current collector 12b can be protected, and hence a short circuit derived from the end of the positive electrode current collector 12b can be prevented. More preferably, as illustrated in FIG. 8, the insulating tape 18 is attached onto both surfaces of the uncoated region U of the positive electrode plate 12 in such a manner as to have the left and right ends of the insulating tape 18 positioned outside the left and right ends of the positive electrode current collector 12b, and thus, left and right end portions of the insulating tape 18 protruding beyond the left and right ends of the positive electrode current collector 12b are attached to each other. In this manner, even if the adhesion between the positive electrode current collector 12b and the insulating tape 18 is low, the protruding portions on the three sides of the insulating tape 18 protruding beyond the upper end and the left and right ends of the positive electrode current collector 12b are mutually bonded with high adhesion of the insulating tape 18, and therefore, the insulating tape 18 can be effectively prevented from peeling. It is noted that an attached portion between the positive electrode tab lead 13 and the insulating tape 18 has a high adhesion area ratio (because the positive electrode tab lead 13 is typically composed of a non-porous material), and hence can originally ensure high adhesion.

The negative electrode plate 14 includes the negative electrode active material layer 14a. A negative electrode active material contained in the negative electrode active material layer 14a contains at least one selected from the group consisting of zinc, zinc oxide, a zinc alloy, and a zinc compound. The zinc may be contained in any form of a zinc metal, a zinc compound, and a zinc alloy as long as it has electrochemical activity suitable for the negative electrode. Preferred examples of the negative electrode material include zinc oxide, a zinc metal, and calcium zincate, and a mixture of a zinc metal and zinc oxide is more preferred. The negative electrode active material may be in the form of a gel, or may be mixed with the electrolytic solution to obtain a negative electrode mixture. For example, a gelled negative electrode can be easily obtained by adding an electrolytic solution and a thickener to a negative electrode active material. Examples of the thickener include polyvinyl alcohol, polyacrylate, CMC, and alginic acid, and polyacrylic acid is preferred because of excellent chemical resistance to strong alkali.

As the zinc alloy, a zinc alloy containing neither mercury nor lead, known as mercury-free zinc alloy, can be used. For example, a zinc alloy containing 0.01 to 0.1% by mass of indium, 0.005 to 0.02% by mass of bismuth, and 0.0035 to 0.015% by mass of aluminum is preferred because it has an effect of inhibiting hydrogen gas generation. In particular, indium and bismuth are advantageous in improving discharge performance. When a zinc alloy is used in the negative electrode, a self-dissolution rate in an alkaline electrolytic solution is decreased to inhibit hydrogen gas generation, and thus, safety can be improved.

The shape of the negative electrode material is not especially limited, and is preferably a powder shape, and thus, the surface area is increased to cope with large current discharge. A preferred average particle size of the negative electrode material is, in using a zinc alloy, in a range of 3 to 100 μm in minor axis, and when the average particle size is within this range, the surface area is so large that large current discharge can be suitably coped with, and in addition, the material can be easily homogeneously mixed with an electrolytic solution and a gelling agent, and handleability in assembling the battery is favorable.

The negative electrode plate 14 further includes a negative electrode current collector 14b. The negative electrode active material layer 14a may be arranged on both surfaces of the negative electrode current collector 14b, or the negative electrode active material layer 14a may be arranged on merely one surface of the negative electrode current collector 14b. The negative electrode current collector 14b preferably uses a metal plate having a plurality of (or a large number of) openings from the viewpoint of fixing the negative electrode active material on the current collector. Preferred examples of such a negative electrode current collector 14b include an expanded metal, a punched metal, a metal mesh, and a combination thereof, more preferred examples include a copper expanded metal, a copper punched metal, and a combination thereof, and a particularly preferred example includes a copper expanded metal. In this case, for example, a negative electrode plate including a negative electrode/negative electrode collector can be favorably produced by applying, on a copper expanded metal, a mixture containing a zinc oxide powder and/or a zinc powder, and optionally a binder (for example, a polytetrafluoroethylene particle). At this point, it is also preferred that the dried negative electrode plate (namely, the negative electrode/negative electrode current collector) is subjected to pressing to prevent the electrode active material from coming off and to improve electrode density. An expanded metal refers to a mesh-shaped metal plate obtained by forming and expanding staggered cuts in a metal plate with an expanded metal machine, and shaping the cuts into a diamond shape or a hexagonal shape. A punched metal is also designated as a perforated metal, and refers to a metal plate provided with holes by punching. A metal mesh is a metal product having a wire mesh structure, and is different from an expanded metal and a punched metal.

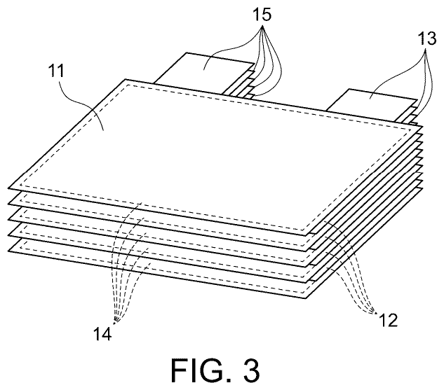

The negative electrode tab lead 15 is provided to extend from an end of the negative electrode plate 14 at a position not overlapping with the positive electrode tab lead 13 (see FIG. 3). The negative electrode tab lead 15 is not especially limited, and a commercially available sheet metal piece may be used. It is preferred that a plurality of negative electrode tab leads 15 are bonded to one negative electrode terminal 28 or a member electrically connected thereto to constitute a negative electrode tab bonding portion 32. In this manner, current collection can be conducted with a simple configuration and with high space efficiency, and connection to the negative electrode terminal 28 can be eased. The bonding between the negative electrode tab lead 15 and the negative electrode current collector 14b, and a member such as the negative electrode terminal 28 may be conducted by any of known bonding methods such as ultrasonic welding (ultrasonic bonding), laser welding, TIG welding, and resistance welding.

As illustrated in FIG. 7, the negative electrode plate 14 has, along the upper end of the negative electrode plate 14, the uncoated region U free from the negative electrode active material layer 14a, and in the uncoated region U, the negative electrode tab lead 15 is weld-bonded to the negative electrode current collector 14b. The insulating tape 18 is attached to the uncoated region U in such a manner as to cover the weld-bonded portion W with the insulating tape 18. Owing to this configuration, as described above, a short circuit caused due to peeling of the negative electrode tab lead 15 can be made difficult to occur. The insulating tape 18 is attached preferably to both surfaces of the negative electrode plate 14. In this case, separate insulating tapes 18 may be attached respectively to one surface and the other surface of the negative electrode plate 14, or one insulating tape 18 may be turned around to be attached to both surfaces of the negative electrode plate 14. In the latter case, one insulating tape 18 may be wound around both surfaces of the negative electrode plate 14 at least once, and in this case, the insulating tape 18 and the negative electrode tab lead 15 is even less likely to peel off. It is preferred that 60% or more, more preferably 70% or more, further preferably 80% or more, and ideally 100% of the area (including the area of a pore if the pore is present) of the uncoated region U on both surfaces of the negative electrode plate 14 is covered with the insulating tape. In this manner, a bonding area between the negative electrode current collector 14b and the insulating tape 18 is increased, and hence the insulating tape 18 is less likely to peel.

The lower end of the insulating tape 18 on the negative electrode plate 14 is preferably positioned between an upper end P₃ of the negative electrode active material layer 14a and a lower end P₂ of the negative electrode tab lead 15. In this case, the lower end of the insulating tape 18 is positioned lower than the lower end P₂ of the negative electrode tab lead 15, and therefore, the tip of the negative electrode tab lead 15 is protected by the insulating tape 18, and thus, the negative electrode tab lead 15 is even less likely to peel, and even if the negative electrode tab lead 15 peels, a short circuit is less likely to occur. Besides, the lower end of the insulating tape 18 is positioned above the upper end P₃ of the negative electrode active material layer, and therefore, a capacity loss can be prevented. Specifically, when the negative electrode active material layer 14a is covered with the insulating tape 18, a region not contributing to a reaction is unavoidably formed, which reduces the battery capacity, but when the above-described configuration is employed, the negative electrode active material layer 14a is not covered with the insulating tape 18, and hence, this problem can be avoided.

It is preferred that the insulating tape 18 is attached onto both surfaces of the uncoated region U of the negative electrode plate 14 in such a manner as to have the upper end of the insulating tape 18 positioned above an upper end P₁ of the negative electrode current collector 14b, and thus, upper end portions of the insulating tape 18 protruding beyond the upper end P₁ of the negative electrode current collector 14b are attached to each other. In this manner, the end of the negative electrode current collector 14b can be protected, and hence a short circuit derived from the end of the negative electrode current collector 14b can be prevented. More preferably, as illustrated in FIG. 8, the insulating tape 18 is attached onto both surfaces of the uncoated region U of the negative electrode plate 14 in such a manner as to have the left and right ends of the insulating tape 18 positioned outside the left and right ends of the negative electrode current collector 14b, and thus, the left and right end portions of the insulating tape 18 protruding beyond the left and right ends of the negative electrode current collector 14b are attached to each other. In this manner, even if the adhesion between the negative electrode current collector 14b and the insulating tape 18 is low, the protruding portions on the three sides of the insulating tape 18 protruding beyond the upper end and the left and right ends of the negative electrode current collector 14b are mutually bonded with high adhesion of the insulating tape 18, and therefore, the insulating tape 18 can be effectively prevented from peeling. For example, when the negative electrode current collector 14b is a porous material such as an expanded metal, a punched metal, or a metal mesh, an adhesion area ratio to the insulating tape 18 is low, and therefore, the adhesion between the negative electrode current collector 14b and the insulating tape 18 is low. Even in such a case, the peeling of the insulating tape 18 can be effectively prevented owing to high adhesion in the protruding portions over the above mentioned three sides. It is noted that an attached portion between the negative electrode tab lead 15 and the insulating tape 18 has a high adhesion area ratio (because the negative electrode tab lead 15 is typically composed of a non-porous material), and hence can originally ensure high adhesion.

The hydroxide ion conductive separator 16 is provided to separate the positive electrode plate 12 and the negative electrode plate 14 such that hydroxide ions can be conducted. For example, as illustrated in FIGS. 4A, 4B, and 6, the positive electrode plate 12 and/or the negative electrode plate 14 (preferably, the negative electrode plate 14) may be covered or wrapped up with the hydroxide ion conductive separator 16. Thus, complicated sealing and bonding between the hydroxide ion conductive separator 16 and the battery container is unnecessary, and hence a nickel-zinc secondary battery (especially a stacked-cell battery thereof) capable of preventing zinc dendrite propagation can be produced extremely easily and with high productivity. A simple configuration in which the hydroxide ion conductive separator 16 is arranged on one side of the positive electrode plate 12 or the negative electrode plate 14 may be employed.

The hydroxide ion conductive separator 16 is not especially limited as long as it is a separator capable of separating the positive electrode plate 12 and the negative electrode plate 14 such that hydroxide ions can be conducted, and representatively is a separator that contains a hydroxide ion conductive solid electrolyte, and selectively passes hydroxide ions by solely utilizing hydroxide ion conductivity. A preferred hydroxide ion conductive solid electrolyte is a layered double hydroxide (LDH) and/or an LDH-like compound. Accordingly, the hydroxide ion conductive separator 16 is preferably an LDH separator. The “LDH separator” herein is a separator containing an LDH and/or an LDH-like compound, and is defined as a separator that selectively passes hydroxide ions by solely utilizing hydroxide ion conductivity of the LDH and/or the LDH-like compound. The “LDH-like compound” herein is a hydroxide and/or oxide having a layered crystal structure analogous to LDH but is a compound that may not be called LDH, and it can be said to be an equivalent of LDH. However, according to a broad sense of definition, it can be appreciated that “LDH” encompasses not only LDH but also LDH-like compounds. The LDH separator is preferably composited with a porous substrate. Accordingly, it is preferred that the LDH separator further includes a porous substrate, and is composited with the porous substrate with the LDH and/or the LDH-like compound filled in pores in the porous substrate. In other words, in a preferred LDH separator, the LDH and/or the LDH-like compound clogs up pores in the porous substrate so that hydroxide ion conductivity and gas impermeability can be exhibited (thereby the LDH separator can function as an LDH separator exhibiting hydroxide ion conductivity). The porous substrate is preferably made of a polymer material, and the LDH is particularly preferably incorporated over the entire area in the thickness direction of the porous substrate made of a polymer material. For example, known LDH separators disclosed in Patent Literatures 1 to 7 can be used. The thickness of the LDH separator is preferably 5 to 100 μm, more preferably 5 to 80 μm, further preferably 5 to 60 μm, and particularly preferably 5 to 40 μm.

It is preferred that not only the hydroxide ion conductive separator 16 but also the liquid holding member 17 is interposed between the positive electrode plate 12 and the negative electrode plate 14. Then, as illustrated in FIGS. 4A, 4B, and 6, the positive electrode plate 12 and/or the negative electrode plate 14 is preferably covered or wrapped up with the liquid holding member 17. A simple configuration in which the liquid holding member 17 is arranged on one side of the positive electrode plate 12 or the negative electrode plate 14 may be employed. In either configuration, since the liquid holding member 17 is thus interposed, the electrolytic solution can be uniformly present between the positive electrode plate 12 and/or the negative electrode plate 14, and the hydroxide ion conductive separator 16, and thus, hydroxide ions can be efficiently transferred between the positive electrode plate 12 and/or the negative electrode plate 14, and the hydroxide ion conductive separator 16. The liquid holding member 17 is not especially limited as long as it is a member capable of holding the electrolytic solution, and is preferably a sheet-shaped member. Preferable examples of the liquid holding member 17 include a nonwoven fabric, a water-absorbent resin, a liquid retaining resin, a porous sheet, and various spacers, and a nonwoven fabric is particularly preferred because a good performance negative electrode structure can be produced at low cost. The liquid holding member 17 or the nonwoven fabric has a thickness of preferably 10 to 200 μm, more preferably 20 to 200 μm, further preferably 20 to 150 μm, particularly preferably 20 to 100 μm, and most preferably 20 to 60 μm. When the thickness falls in this range, with the entire size of the positive electrode structure and/or the negative electrode structure efficiently suppressed to be compact, a sufficient amount of the electrolytic solution can be held in the liquid holding member 17.

When the positive electrode plate 12 and/or the negative electrode plate 14 is covered or wrapped up with the liquid holding member 17 and/or the separator 16, the outer edges thereof (excluding the sides from which the positive electrode tab lead 13 and the negative electrode tab lead 15 extend) are preferably closed. In this case, closed sides of the outer edges of the liquid holding member 17 and/or the separator 16 are preferably realized by bending the liquid holding member 17 and/or the separator 16, or sealing the edges of the liquid holding member 17 and/or the edges of the separator 16. Preferred examples of the sealing method include an adhesive, thermal welding, ultrasonic welding, an adhesive tape, a sealing tape, and a combination thereof. In particular, an LDH separator including a porous substrate made of a polymer material has flexibility, and hence is advantageously easily bent, and therefore, it is preferred that the LDH separator formed into a rectangular shape is bent to obtain a state where one side of the outer edges is closed. For thermal welding and ultrasonic welding, a commercially available heat sealer or the like may be used, and in sealing the edges of an LDH separator, it is preferred to perform the thermal welding and the ultrasonic welding with an outer circumferential portion of the liquid holding member 17 sandwiched between outer circumferential portions of the LDH separator because the sealing can be thus more effectively performed. On the other hand, as an adhesive, an adhesive tape, and a sealing tape, commercially available products may be used, and in order to prevent deterioration otherwise caused in an alkaline electrolytic solution, one containing an alkali resistant resin is preferred. From this point of view, preferred examples of the adhesive include an epoxy resin-based adhesive, a natural resin-based adhesive, a modified olefin resin-based adhesive, and a modified silicone resin-based adhesive, among which an epoxy resin-based adhesive is more preferred because of excellent alkali resistance. An example of products of the epoxy resin-based adhesive includes an epoxy adhesive, Hysol® (manufactured by Henkel).

The outer edge on one side corresponding to the upper edge of the separator 16 is preferably opened. Such a top open type configuration makes it possible to deal with a problem occurring upon overcharge in a nickel-zinc battery and the like. Specifically, when a nickel-zinc battery or the like is overcharged, oxygen (O₂) can be generated in the positive electrode plate 12, but the LDH separator has such a high density as to substantially pass only hydroxide ions, and hence does not pass O₂. In this regard, when the above-described top open type configuration is employed, O₂ can be transferred above the positive electrode plate 12 to be sent toward the negative electrode plate 14 through the top open portion in the battery case 20, and thus, Zn of a negative electrode active material can be oxidized with the O₂ to be restored to ZnO. Owing to such an oxygen reaction cycle, overcharge resistance can be improved by using top open type electrode laminate 11 in a sealed zinc secondary battery. Even when the outer edge on one side corresponding to the upper edge of the separator 16 or the liquid holding member 17 is closed, the same effect as that obtained by the open type configuration can be expected by providing a vent hole in a part of the closed outer edge. For example, a vent hole may be formed after sealing the outer edge on one side corresponding to the upper edge of the LDH separator, or a part of the outer edge may be left unsealed in sealing so as to form a vent hole therein.

The electrolytic solution preferably contains an alkali metal hydroxide aqueous solution. Although the electrolytic solution is not illustrated in FIGS. 1 to 4B, this is because the electrolytic solution spreads all over the positive electrode plate 12 and the negative electrode plate 14. Examples of an alkali metal hydroxide include potassium hydroxide, sodium hydroxide, lithium hydroxide, and ammonium hydroxide, and potassium hydroxide is more preferred. In order to inhibit self-dissolution of zinc and/or zinc oxide, a zinc compound such as zinc oxide, or zinc hydroxide may be added to the electrolytic solution. As described above, the electrolytic solution may be mixed with the positive electrode active material and/or the negative electrode active material so as to be present in the form of a positive electrode mixture and/or a negative electrode mixture. Besides, the electrolytic solution may be gelled for preventing leakage of the electrolytic solution. As a gelling agent, a polymer that absorbs a solvent of the electrolytic solution to swell is preferably used, and a polymer such as polyethylene oxide, polyvinyl alcohol, or polyacrylamide, or starch is used.

The electrode laminate 11 is a laminate including a plurality of electrode layers. The electrode laminate 11 is preferably formed, as illustrated in FIGS. 3, 4A, and 4B, into a positive/negative electrode laminate including a plurality of positive electrode plates 12, a plurality of negative electrode plates 14, and a plurality of separators 16 in which a unit of the positive electrode plate 12/the separator 16/the negative electrode plate 14 is repeatedly stacked. In other words, it is preferred that the zinc secondary battery 10 includes a plurality of unit cells 10a each including a pair of the positive electrode plate 12 and the negative electrode plate 14 together with the hydroxide ion conductive separator 16, and thus, the plurality of unit cells 10a form a multilayer cell as a whole. This is a configuration of what is called a battery pack or stacked cell battery, and this configuration is advantageous in obtaining a high voltage and a large current.

The battery case 20 is preferably made of a resin. The resin constituting the battery case 20 is preferably a resin having resistance to an alkali metal hydroxide such as potassium hydroxide, more preferably a polyolefin resin, an ABS resin, or modified polyphenylene ether, and further preferably an ABS resin or modified polyphenylene ether. The battery case 20 has a top cover 20a. The battery case 20 (for example, the top cover 20a) may have a pressure release valve for releasing a gas. Besides, a case group in which two or more battery cases 20 are arranged may be housed in an outer frame to obtain a configuration of a battery module.

### LDH-Like Compounds

According to a preferred aspect of the present invention, the LDH separator can be a separator that contains an LDH-like compound. The definition of the LDH-like compound is as described above. Preferred LDH-like compounds are as follows,
(a) a hydroxide and/or oxide having a layered crystal structure containing Mg and one or more elements selected from the group consisting of Ti, Y, and Al, and containing at least Ti; or
(b) a hydroxide and/or oxide having a layered crystal structure containing (i) Ti, Y, optionally Al and/or Mg, and (ii) at least one additive element M selected from the group consisting of In, Bi, Ca, Sr and Ba, or
(c) a hydroxide and/or oxide having a layered crystal structure containing Mg, Ti, Y, optionally Al and/or In, wherein in (c), the LDH-like compound is present in a form of mixture with In(OH)₃.

According to the preferred aspect (a) of the present invention, the LDH-like compound can be a hydroxide and/or oxide having a layered crystal structure containing Mg and one or more elements selected from the group consisting of Ti, Y and Al and containing at least Ti. Thus, a typical LDH-like compound is a complex hydroxide and/or complex oxide of Mg, Ti, optionally Y and optionally Al. The above elements may be replaced with other elements or ions to an extent that the basic characteristics of the LDH-like compound are not impaired, but the LDH-like compound preferably contains no Ni. For example, the LHD-like compound may be a compound further containing Zn and/or K. In such a manner, ionic conductivity of the LDH separator can be further improved.

LDH-like compounds can be identified by X-ray diffraction. Specifically, when X-ray diffraction is carried out on the surface of the LDH separator, a peak assigned to the LDH-like compound is detected typically in the range of 5°≤2θ≤10°, and more typically in the range of 7°≤2θ≤10°. As described above, the LDH is a substance having an alternating laminated structure in which exchangeable anions and H₂O are present as an intermediate layer between the stacked hydroxide basic layers. In this regard, when LDH is analyzed by the X-ray diffraction method, a peak assigned to the crystal structure of LDH (i.e., the peak assigned to (003) of LDH) is originally detected at a position of 2θ=11 to 12°. When the LDH-like compound is analyzed by the X-ray diffraction method, on the other hand, a peak is typically detected in the aforementioned range shifted to the lower angle side than the above peak position of LDH. Further, the interlayer distance of the layered crystal structure can be determined by Bragg's equation using 2θ corresponding to the peak assigned to the LDH-like compound in X-ray diffraction. The interlayer distance of the layered crystal structure of the LDH-like compound thus determined is typically 0.883 to 1.8 nm, and more typically 0.883 to 1.3 nm.

The LDH separator by the aforementioned aspect (a) has an atomic ratio of Mg/(Mg+Ti+Y+Al) in the LDH-like compound, as determined by energy dispersive X-ray spectroscopy (EDS), which is preferably 0.03 to 0.25 and more preferably 0.05 to 0.2. Moreover, the atomic ratio of Ti/(Mg+Ti+Y+Al) in the LDH-like compound is preferably 0.40 to 0.97 and more preferably 0.47 to 0.94. Further, the atomic ratio of Y/(Mg+Ti+Y+Al) in the LDH-like compound is preferably 0 to 0.45 and more preferably 0 to 0.37. Further, the atomic ratio of Al/(Mg+Ti+Y+Al) in the LDH-like compound is preferably 0 to 0.05 and more preferably 0 to 0.03. Within the above ranges, the alkali resistance is more excellent, and the effect of inhibiting a short circuit due to zinc dendrite (i.e., dendrite resistance) can be more effectively realized. By the way, LDH conventionally known for LDH separators has the basic composition that can be represented by the formula: M²⁺₁₋ₓM³⁺ₓ(OH)₂Aⁿ⁻_{x/n}·mH₂O, wherein M²⁺ is a divalent cation, M³⁺ is a trivalent cation, Aⁿ⁻ is an n-valent anion, n is an integer of 1 or more, x is 0.1 to 0.4, and m is 0 or more. The atomic ratios in the LDH-like compound generally deviate from those in the above formula for LDH. Therefore, the LDH-like compound in the present aspect generally can be said to have a composition ratio (atomic ratio) different from that of the conventional LDH. EDS analysis is preferably carried out with an EDS analyzer (for example, X-act, manufactured by Oxford Instruments Plc.), by 1) capturing an image at an acceleration voltage of 20 kV and a magnification of 5,000×, 2) carrying out three-point analysis at intervals of about 5 μm in the point analysis mode, 3) repeating the above 1) and 2) once more, and 4) calculating the average value of a total of 6 points.

According to another preferred aspect (b) of the present invention, the LDH-like compound can be a hydroxide and/or oxide having a layered crystal structure containing (i) Ti, Y, and optionally Al and/or Mg and (ii) additive element M. Therefore, a typical LDH-like compound is a complex hydroxide and/or complex oxide of Ti, Y, additive element M, optionally Al and optionally Mg. Additive element M is In, Bi, Ca, Sr, Ba or combinations thereof. The above elements may be replaced with other elements or ions to an extent such that the basic characteristics of the LDH-like compound are not impaired, but the LDH-like compound preferably contains no Ni.

The LDH separator by the aforementioned aspect (b) has an atomic ratio of Ti/(Mg+Al+Ti+Y+M) in the LDH-like compound, as determined by energy dispersive X-ray spectroscopy (EDS), which is preferably 0.50 to 0.85 and more preferably 0.56 to 0.81. The atomic ratio of Y/(Mg+Al+Ti+Y+M) in the LDH-like compound is preferably 0.03 to 0.20 and more preferably 0.07 to 0.15. The atomic ratio of M/(Mg+Al+Ti+Y+M) in the LDH-like compound is preferably 0.03 to 0.35 and more preferably 0.03 to 0.32. The atomic ratio of Mg/(Mg+Al+Ti+Y+M) in the LDH-like compound is preferably 0 to 0.10 and more preferably 0 to 0.02. Then, the atomic ratio of Al/(Mg+Al+Ti+Y+M) in the LDH-like compound is preferably 0 to 0.05 and more preferably 0 to 0.04. Within the above ranges, the alkali resistance is more excellent, and the effect of inhibiting a short circuit due to zinc dendrite (i.e., dendrite resistance) can be more effectively realized. By the way, LDH conventionally known for LDH separators has the basic composition that can be represented by the formula: M²⁺₁₋ₓM³⁺ₓ(OH)₂Aⁿ⁻_{x/n}·mH₂O, wherein M²⁺ is a divalent cation, M³⁺ is a trivalent cation, Aⁿ⁻ is an n-valent anion, n is an integer of 1 or more, x is 0.1 to 0.4, and m is 0 or more. The atomic ratios in the LDH-like compound generally deviate from those in the above formula for LDH. Therefore, the LDH-like compound in the present aspect generally can be said to have a composition ratio (atomic ratio) different from that of the conventional LDH. EDS analysis is preferably carried out with an EDS analyzer (for example, X-act, manufactured by Oxford Instruments Plc.), by 1) capturing an image at an acceleration voltage of 20 kV and a magnification of 5,000×, 2) carrying out three-point analysis at intervals of about 5 μm in the point analysis mode, 3) repeating the above 1) and 2) once more, and 4) calculating the average value of a total of 6 points.

According to another further preferred aspect (c) of the present invention, the LDH-like compound can be a hydroxide and/or oxide having a layered crystal structure containing Mg, Ti, Y, and optionally Al and/or In, wherein the LDH-like compound is present in a form of mixture with In(OH)₃. The LDH-like compound in this aspect is a hydroxide and/or oxide having a layered crystal structure containing Mg, Ti, Y, and optionally Al and/or In. Therefore, a typical LDH-like compound is a complex hydroxide and/or complex oxide of Mg, Ti, Y, optionally Al and optionally In. The In that can be contained in the LDH-like compound may be not only In intentionally added to the LDH-like compound but also that unavoidably mixed into the LDH-like compound, due to formation of In(OH)₃ or the like. The above elements can be replaced with other elements or ions to an extent that the basic characteristics of the LDH-like compound are not impaired, however, the LDH-like compound preferably contains no Ni. By the way, LDH conventionally known for LDH separators has the basic composition that can be represented by the formula: M²⁺₁₋ₓM³⁺ₓ(OH)₂Aⁿ⁻_{x/n}·mH₂O, wherein M²⁺ is a divalent cation, M³⁺ is a trivalent cation, Aⁿ⁻ is an n-valent anion, n is an integer of 1 or more, x is 0.1 to 0.4, and m is 0 or more. The atomic ratios in the LDH-like compound generally deviate from those in the above formula for LDH. Therefore, the LDH-like compound in the present aspect generally can be said to have a composition ratio (atomic ratio) different from that of the conventional LDH.

The mixture by the above aspect (c) contains not only the LDH-like compound but also In(OH)₃ (typically composed of the LDH-like compound and In(OH)₃). In(OH)₃ contained can effectively improve alkali resistance and dendrite resistance in LDH separators. The content proportion of In(OH)₃ in the mixture is preferably the amount that can improve alkali resistance and dendrite resistance with little impairment of hydroxide ion conductivity of the LDH separator, and is not particularly limited. In(OH)₃ may have a cubic crystal structure, and have a configuration in which the crystals of In(OH)₃ are surrounded by LDH-like compounds. In(OH)₃ can be identified by X-ray diffraction.

What is claimed is:

1. A zinc secondary battery, comprising:
a positive electrode plate including a positive electrode active material layer and a positive electrode current collector;
a positive electrode tab lead extending from an end of the positive electrode plate;
a negative electrode plate including a negative electrode active material layer containing at least one selected from the group consisting of zinc, zinc oxide, a zinc alloy, and a zinc compound, and a negative electrode current collector;
a negative electrode tab lead extending from an end of the negative electrode plate at a position not overlapping with the positive electrode tab lead;
a hydroxide ion conductive separator separating the positive electrode plate and the negative electrode plate so as to make hydroxide ions conductible; and
an electrolytic solution,
wherein each of the positive electrode plate, the positive electrode tab lead, the negative electrode plate, the negative electrode tab lead, and the hydroxide ion conductive separator is vertically arranged, and the positive electrode tab lead and the negative electrode tab lead extend upward,
wherein the positive electrode plate has, along an upper end of the positive electrode plate, an uncoated region free from the positive electrode active material layer, and the positive electrode tab lead is weld-bonded to the positive electrode current collector in the uncoated region, and an insulating tape is attached to the uncoated region in such a manner as to cover the weld-bonded portion with the insulating tape, and/or
wherein the negative electrode plate has, along an upper end of the negative electrode plate, an uncoated region free from the negative electrode active material layer, and the negative electrode tab lead is weld-bonded to the negative electrode current collector in the uncoated region, and an insulating tape is attached to the uncoated region in such a manner as to cover the weld-bonded portion with the insulating tape.

2. The zinc secondary battery according to claim 1, wherein 60% or more of an area of the uncoated region on both surfaces of the positive electrode plate is covered with the insulating tape, and/or 60% or more of an area of the uncoated region on both surfaces of the negative electrode plate is covered with the insulating tape.

3. The zinc secondary battery according to claim 1,
wherein a lower end of the insulating tape on the positive electrode plate is positioned between an upper end of the positive electrode active material layer and a lower end of the positive electrode tab lead, and/or
wherein a lower end of the insulating tape on the negative electrode plate is positioned between an upper end of the negative electrode active material layer and a lower end of the negative electrode tab lead.

4. The zinc secondary battery according to claim 1,
wherein the insulating tape is attached to both surfaces of the uncoated region of the positive electrode plate in such a manner as to have an upper end of the insulating tape positioned above an upper end of the positive electrode current collector, whereby upper end portions of the insulating tape protruding beyond the upper end of the positive electrode current collector are attached to each other, and/or
wherein the insulating tape is attached to both surfaces of the uncoated region of the negative electrode plate in such a manner as to have an upper end of the insulating tape positioned above an upper end of the negative electrode current collector, whereby upper end portions of the insulating tape protruding beyond the upper end of the negative electrode current collector are attached to each other.

5. The zinc secondary battery according to claim 4,
wherein the insulating tape is attached to both surfaces of the uncoated region of the positive electrode plate in such a manner as to have left and right ends of the insulating tape positioned outside left and right ends of the positive electrode current collector, and left and right end portions of the insulating tape protruding beyond the left and right end of the positive electrode current collector are attached to each other, and/or
wherein the insulating tape is attached to both surfaces of the uncoated region of the negative electrode plate in such a manner as to have left and right ends of the insulating tape positioned outside left and right ends of the negative electrode current collector, and left and right end portions of the insulating tape protruding beyond the left and right end of the negative electrode current collector are attached to each other.

6. The zinc secondary battery according to claim 1, wherein the positive electrode plate and/or the negative electrode plate is covered or wrapped up with the hydroxide ion conductive separator.

7. The zinc secondary battery according to claim 1, wherein not only the hydroxide ion conductive separator but also a liquid holding member is interposed between the positive electrode plate and the negative electrode plate.

8. The zinc secondary battery according to claim 7, wherein the positive electrode plate and/or the negative electrode plate is covered or wrapped up with the liquid holding member.

9. The zinc secondary battery according to claim 1, wherein the hydroxide ion conductive separator is an LDH separator containing a layered double hydroxide (LDH) and/or an LDH-like compound.

10. The zinc secondary battery according to claim 9, wherein the LDH separator further includes a porous substrate, and is composited with the porous substrate with the LDH and/or the LDH-like compound filled in pores in the porous substrate.

11. The zinc secondary battery according to claim 1, wherein the positive electrode active material layer contains nickel hydroxide and/or nickel oxyhydroxide, whereby the zinc secondary battery is configured as a nickel zinc secondary battery.

12. The zinc secondary battery according to claim 1, wherein the positive electrode active material layer is an air electrode layer, whereby the zinc secondary battery is configured as an air-zinc secondary battery.

13. The zinc secondary battery according to claim 1, comprising a plurality of unit cells each including a pair of the positive electrode plate and the negative electrode plate together with the hydroxide ion conductive separator, whereby the plurality of the unit cells form a multilayer cell as a whole.
